(19) United States
(12) Patent Application Publication
(10) Pub. No.: US 2005/0091052 A1
(43) Pub. Date: Apr. 28, 2005

(54) Variable frequency decoding apparatus for efficient power management in a portable audio device

(76) Inventors: Yuh-Chin Chang, Hsinchu (TW); Peng-Cheng Chen, Hsinchu (TW); Hui-Ya Chou, Hsinchu (TW); Hong-Tsan Lee, Hsinchu (TW)

Correspondence Address: VENABLE, BAETJER, HOWARD AND CIVILETTI, LLP, P.O. BOX 34385, WASHINGTON, DC, 20043-9998, US

(21) Appl. No.: 10/758,533

(22) Filed: Jan. 16, 2004

(30) Foreign Application Priority Data
Oct. 14, 2003 (TW) 092128356

(51) Int. Cl. G10L 19/02

(52) U.S. Cl. 704/229

(57) ABSTRACT

A variable frequency decoding apparatus operable in a portable audio device that can improve the power management is disclosed. The above apparatus has a decoder and a clock generator that provides the system clock for the decoder. When a bit stream representing audio compressed data is received, the decoder simultaneously provides the audio information embedded in the audio compressed data such as the bit rate and the sampling frequency of the data frame to the clock generator, and then the clock generator adjusts the clock signals; which are used by the decoder to restore to the original PCM format, to match the audio information embedded in the data frame. This audio signal compression technique can prevent possible output delay and reduce power consumption as compared with the conventional way that used a fixed sys clock.

### BACKGROUND OF THE INVENTION

1. Field of the Invention

The present invention is related to a variable frequency decoding apparatus for efficient power management in a portable audio device, or more particularly to the application of an audio and speech compression technique to decode audio compressed data with variable sampling frequency for reduced power usage.

2. Description of Related Art

Conventional portable audio devices, such as CD players or digital voice recorders, use one or more decoders to decode audio compressed data coded in MPEG audio Layer 3 (MP3), Windows Media Audio Code (WMA), or Algebraic Code Excited Linear Prediction (ACELP) format. The structure of the above variable frequency decoding apparatus, as shown in FIG. 3, generally consists of a decoder (70), an audio signal processor (DSP) (71), and a clock generation unit (80).

The decoder (70), in compliance with MP3 and WMA specifications, is used for decoding the input audio compressed data to restore to the original pulse code modulation (PCM) signals for output through an output buffer.

The audio signal processor (DSP) (71) is installed between the above decoder (70) and the speaker or earphone to process the decoded PCM signals, which are then output to a speaker through an output buffer.

The clock generation unit (80) consists of a microprocessor (81) and a clock circuit (82).

The microprocessor (81) receives audio information such as the bit rate and the sampling frequency embedded in the input audio compressed data when these data are input to the decoder (70). This information is used at the system initialization for setting up the sys clock (system clock). The microprocessor (81) then sends out a parameter to the clock circuit (82), which then synchronizes with the output (PLLCLK) of a phase-lock loop to generate the required sys clock with a predetermined frequency. The stream of clock signals is passed to the input (DSPCLK) of the decoder (70), basing on which the decoder (70) decodes the input audio compressed data and restores them to the original PCM code format.

In conventional audio signal decoding apparatus, the sys clock, provided by the microprocessor (81) in the clock generation unit (80), is set at the system initialization. However, if the input audio compressed data are coded with variable bit rate (VBR), then the operation clock has to be adjusted to carry a frequency higher than the average VBR, because the decoded data frames would otherwise experience some output delay. The conventional variable frequency decoding apparatus therefore has to use over-spec frequency clock signals for normal decoding, thus resulting in unnecessary power consumption. For MP3 coded audio compressed data basing on a sampling rate of 44.1 kilo hertz (KHz) and a bit rate of 64 kilo bit per second (KBPS), it should not consume more power than one basing on 44.1 KHz sampling rate and 128 KBPS bit rate.

For the manufacturers of portable audio devices, smart power management is a low cost option that can be readily applied to extend the operation time of the portable audio devices. In view of the current practice of a variety of sampling frequencies, the input audio compressed data should be categorized into different classes in order to economize on the internal power usage, as the clock circuit is a major power use in the system.

To realize the power saving scheme, the device needs the capability to extract the audio information embedded in the audio compressed data, such as the bit rate and the sampling frequency, when the audio compressed data is received by the decoder. Also, the device should be able to select an appropriate clock frequency for decoding the input audio compressed data for optimal performance. The variable frequency decoding technique can help extend the operation time of portable audio devices by reducing the operation clock rate of the audio device, which has been a major power user in the audio device, thus cutting down unnecessary power consumption as compared with the conventional way of using a fixed sys clock.

### SUMMARY OF THE INVENTION

The main objective of the present invention is to provide a variable frequency decoding apparatus that is capable of using variable frequency sys clock and variable bit rate (VBR) to match the audio compressed data format for decoding and restoring to the PCM signals. Such application of variable bit rate (VBR) can help extend the operation time of the portable audio devices by reducing the frequency of operation clock, which is the main power user in an audio device, thus preventing unnecessary power consumption.

To this end, the variable frequency decoding apparatus, in accordance with the present invention, includes at least one decoder and a clock generator for the generation of system clock used by the decoder.

In actual operation, the decoder simultaneously provides the decompressed audio information such as bit rate and the sampling frequency of the data frame embedded in the audio compressed data to the clock generator, when the decoder receives the input audio compressed data. The clock generator then simultaneously adjusts the sys clock basing on the most recent bit rate and the sampling frequency received from the decoder. It should be noted that the sys clock required by the decoder can be tuned to match the bit rate and the sampling frequency of the input audio compressed data frame-by-frame for optimal performance, thus obviating the problem of output delay and unnecessary power consumption due to the use of a fixed sys clock.

The structure of the above mentioned clock generator includes a look-up table and a clock circuit.

The look-up table contains a list of predetermined frequencies that correspond to the different bit rates and sampling frequencies used in encoding the audio compressed data, such that an appropriate sys clock can be simultaneously provided to the decoder to match the input format of audio compressed data.

The clock circuit is used to generate the required sys clock basing on the predetermined frequency selected from the look-up table, which is then provided to the decoder for signal processing.

According to the present invention, the clock circuit in the above mentioned clock generator may produce two different operation clock outputs, respectively represented by a first clock and a second clock for improved switching efficiency. The operation clock is controlled by a switching circuit which is connected to the sys clock input of the decoder, through which an appropriate sys clock can be selected from between the first and second clock for giving the optimal performance of the decoder.

According to the present invention, the above switching circuit is capable of preventing electromagnetic interference in the form of glitches.

According to the present invention, the above look-up table may be embedded in a microprocessor.

Other objectives, advantages and novel features of the invention will become more apparent from the following detailed description when taken in conjunction with the accompanying drawings.

### BRIEF DESCRIPTION OF THE DRAWINGS

FIG. 1 is a system block diagram for the first preferred embodiment of the invention;

FIG. 2 is a system block diagram for the second preferred embodiment of the invention; and

FIG. 3 is a system block diagram for a conventional variable frequency decoding apparatus.

### DETAILED DESCRIPTION OF THE PREFERRED EMBODIMENT

The present invention can be implemented through two preferred embodiments with slightly different structures. These two preferred embodiments will now be described with reference to the accompanying drawings.

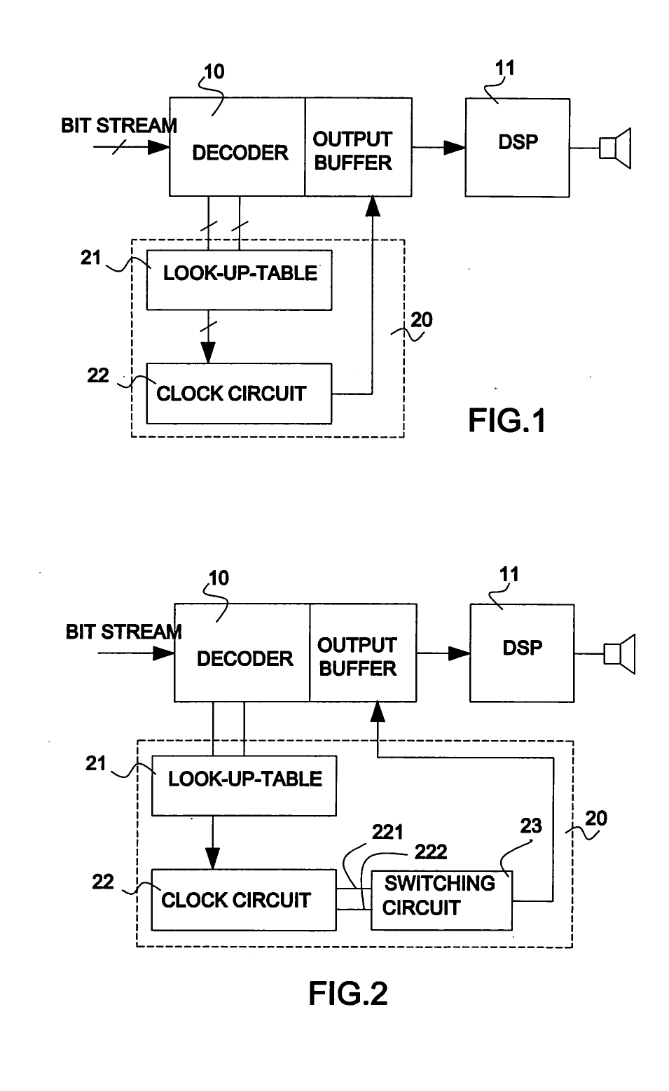

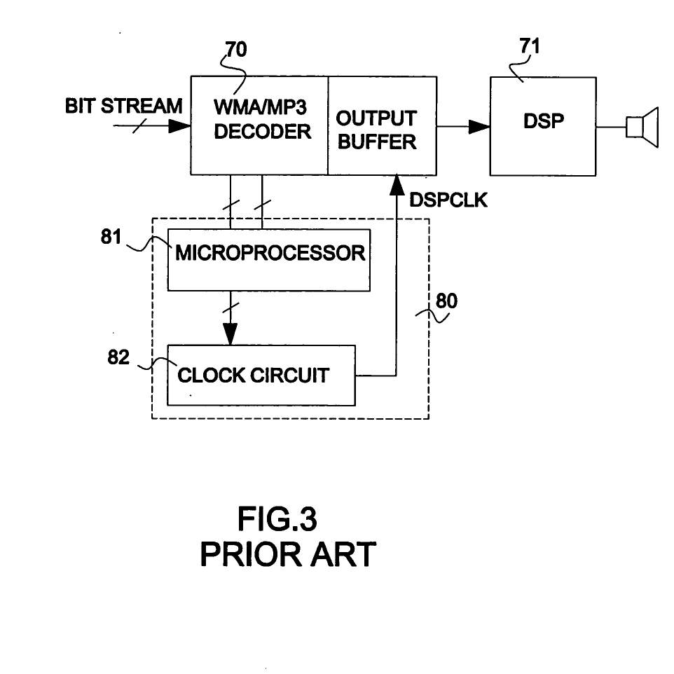

In FIG. 1, the structure of the first preferred embodiment includes a decoder (10), a clock generator (20), and an audio signal processor (DSP) (11).

The decoder (10) , complying with MP3 or WMA specifications, is used for decoding the audio compressed data format and restoring the compressed data to the original PCM signals, which are then passed through a buffer to the audio signal processor (DSP) (11) en route to a speaker or earphone.

A clock generator (20), containing a look-up table (21) and a clock circuit (22), is used to generate the required sys clock for the decoder (10) operation, wherein the look-up table (21) is built in with a list of predetermined frequencies to correspond to different bit rates and sampling frequencies used in encoding the audio compressed data, and the look-up table (21) may be embedded in a microprocessor, as in the present example. The above clock circuit (22) then selects a predetermined frequency for generation of the required sys clock basing on the information from the look-up table (21), which is then passed to the decoder (10).

The sequence of operation is now explained in accordance with the present invention. When a bit stream representing audio compressed data is received by the decoder (10), the decoder (10) simultaneously passes the decompressed audio information such as the bit rate and the sampling frequency of the data frame embedded in the audio compressed data to the clock generator (20). Then, the clock generator (20) adjusts to an appropriate operation clock to match the audio compressed data, and generates the required sys clock and passes it to the decoder (10) for decoding the audio compressed data.

Since the above mentioned variable frequency decoding apparatus can simultaneously adjust the sys clock basing on the decompressed audio information such as bit rate and the sampling frequency frame-by-frame in the data decoding processing for achieving optimal performance. Thus the present invention can obviate the previous problem of output delay and unnecessary power consumption due to use of a fixed sys clock with excessively high operation frequency.

In FIG. 2, another preferred embodiment is shown with a slightly modified system structure, that is the clock circuit (22) of the clock generator (20) has two outputs, represented by a first clock (221) and a second clock (222), and that a switching circuit (23) is installed between the sys clock input to the decoder (10) and the first and second clock (221)/(222) output. The switching circuit (23) is designed to be able to prevent electromagnetic interference in the form of glitches, by which the sys clock output to the decoder (10) is switched between the first clock (221) and the second clock (222) for improved efficiency.

The dynamic adjustment of sys clock in accordance with the currently decoded audio information such as bit rate and sampling frequency of the data frame allows the decoder in a portable audio device to give stable performance and realize efficient power management.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A variable frequency decoding apparatus for efficient power management in a portable audio device, comprising:
a decoder which simultaneously outputs audio information including a bit rate and a sampling frequency of a data frame to a clock generator when audio compressed data is received, wherein the clock generator has an input connected to the decoder for receiving the audio information, such that an operation frequency of the sys clock can be changed to match the sampling frequency and the bit rate of the data frame for decoding with optimal performance.

2. The variable frequency decoding apparatus as claimed in claim 1, wherein the clock generator includes:
a look-up table built in with a list of predetermined frequencies corresponding to different bit rates and sampling frequencies used to encode audio data, such that an appropriate sys clock can be simultaneously generated after comparing the audio information, which is used by the decoder in decoding the audio compressed data; and
a clock circuit which is used to generate the required sys clock with predetermined frequency selected from the look-up table, to be used by the decoder.

3. The variable frequency decoding apparatus as claimed in claim 2, wherein the clock circuit in the clock generator has two outputs respectively for a first and a second clock, and the two outputs of the first and second clock are selectively connected to the sys clock input of the decoder and controlled by a switching circuit, through which the sys clock is passed to the decoder for improved efficiency.

4. The variable frequency decoding apparatus as claimed in claim 3, the switching circuit is capable of preventing electromagnetic interference in the form of glitches.

5. The variable frequency decoding apparatus as claimed in claim 2, wherein the look-up table in the clock generator may be embedded in a microprocessor.

6. The variable frequency decoding apparatus as claimed in claim 3, wherein the look-up table in the clock generator may be embedded in a microprocessor.

7. The variable frequency decoding apparatus as claimed in claim 4, wherein the look-up table in the clock generator may be embedded in a microprocessor.
